(19) United States
(12) Patent Application Publication
(10) Pub. No.: US 2023/0027364 A1
(43) Pub. Date: Jan. 26, 2023

(54) INK JET TEXTILE PRINTING INK AND INK JET TEXTILE PRINTING METHOD

(71) Applicant: FUJIFILM Corporation, Tokyo (JP)

(72) Inventor: Masao IKOSHI, Kanagawa (JP)

(73) Assignee: FUJIFILM Corporation, Tokyo (JP)

(21) Appl. No.: 17/949,207

(22) Filed: Sep. 20, 2022

Related U.S. Application Data
(63) Continuation of application No. PCT/JP2020/044077, filed on Nov. 26, 2020.

(30) Foreign Application Priority Data
Mar. 27, 2020 (JP) 2020-058270

(51) Int. Cl. C09D 11/328; D06P 5/30

(52) U.S. Cl. CPC C09D 11/328; D06P 5/30

(57) ABSTRACT

An ink jet textile printing ink containing: water; a coloring material; a polymer X which is a water-soluble polymer with a weight-average molecular weight of 6,000 to 35,000, including at least one selected from the group consisting of a structural unit derived from alkylene glycol, a structural unit derived from vinyl alcohol, and the like; a solvent A which is a water-soluble organic solvent with a molecular weight of 160 or less, in which a ratio of the solvent A in all water-soluble organic solvents contained is 70 mass % or greater, a content of the polymer X is greater than 0.8 mass % and 7.0 mass % or less, and a content mass ratio [solvent A/polymer X] is 7.0 to 50.

### CROSS-REFERENCE TO RELATED APPLICATION

This application is a continuation application of International Application No. PCT/JP2020/044077, filed Nov. 26, 2020, the disclosure of which is incorporated herein by reference in its entirety. Further, this application claims priority from Japanese Patent Application No. 2020-058270, filed Mar. 27, 2020, the disclosure of which is incorporated herein by reference in their entirety.

### BACKGROUND OF THE INVENTION

### 1. Field of the Invention

The present disclosure relates to an ink jet textile printing ink and an ink jet textile printing method.

### 2. Description of the Related Art

In recent years, technologies related to textile printing on a fabric by an ink jet method have been studied.

For example, JP2019-501043A discloses an ink which can be perfectly printed in a single pass (particularly, recirculation type) ink jet printer, is capable of producing printed cloth that is excellent in optical density, chroma saturation, crock fastness, fastness to washing with respect to discoloration and staining, and the like, contains a self-dispersing pigment containing a carboxy functional dispersing agent crosslinked around a pigment core by a crosslinking agent having at least two specific groups, a specific binder having Tg in a range of −25 C to 35° C., a hydrophilic organic solvent, a surfactant, a biocide, a viscosity modifier, and water, and has a viscosity in a specific range.

WO2016/125869A discloses a textile printing ink jet ink which can maintain good permeability to a rear surface of a fabric and a good density on a surface of the fabric even in rapid recording, can be improved in storage stability and jetting stability of the ink jet ink and in drying properties of a fabric and the like, and contains polyalkylene glycol, a dispersed dye, and an anionic dispersing agent, in which a weight-average molecular weight of the polyalkylene glycol is 400 or greater and 1,000 or less.

JP2016-155968A discloses a reactive dye ink which is excellent in jetting stability in a printer having an industrial ink jet head requiring a high-viscosity ink, is excellent in storage stability and in sticking properties to fibers, and contains at least one reactive dye, water, and a compound having a specific polyalkylene glycol structure with a weight-average molecular weight of 2,300 or greater.

JP2002-20663A discloses an ink for ink jet which has good dispersion stability and long-term storage stability, does not cause clogging of a filter or a nozzle during continuous jetting, and has excellent color-developing and dyeing properties, in which particles, made of a block polymer obtained by bonding a polymer block A with a dye dissolved or dispersed therein which is obtained by polymerizing a monomer having an ethylenically unsaturated double bond with a dye dissolved or dispersed therein to a block consisting of a block B or blocks B and C improving dispersibility, are dispersed in a medium.

### SUMMARY OF THE INVENTION

In the textile printing on a fabric by an ink jet method (hereinafter, also referred to as “ink jet textile printing”), it may be required to achieve both the jetting stability of the ink from the ink jet head and the drying properties of an image recorded on the fabric.

In addition, in the ink jet textile printing, the ink circulating between the ink tank and the ink jet head may be required to have circulation suitability.

An object to be achieved by one aspect of the present disclosure is to provide an ink jet textile printing method which is excellent in jetting stability of an ink from an ink jet head, drying properties of an image recorded on a fabric, and circulation suitability of the ink, and an ink jet textile printing ink with which the ink jet textile printing method can be performed.

Specific methods for achieving the above object include the following aspects.

<1> An ink jet textile printing ink containing:

water;

a coloring material;

a polymer X which is a water-soluble polymer with a weight-average molecular weight of 6,000 to 35,000, including at least one selected from the group consisting of a structural unit derived from alkylene glycol, a structural unit derived from vinyl alcohol, a structural unit derived from vinyl acetate, and a structural unit derived from vinylpyrrolidone; and

a solvent A which is a water-soluble organic solvent with a molecular weight of 160 or less,

in which a ratio of the solvent A in all water-soluble organic solvents contained in the ink jet textile printing ink is 70 mass % or greater,

a content of the polymer X with respect to a total amount of the ink jet textile printing ink is 0.9 mass % to 6.0 mass %, and

a mass ratio of a content of the solvent A to the content of the polymer X is 7.0 to 50.

<2> The ink jet textile printing ink according to <1>, in which a viscosity at 25° C. is 8 mPa·s to 16 mPa·s.

<3> The ink jet textile printing ink according to <1> or <2>, in which a mass ratio of a content of the coloring material to the content of the polymer X is 2.5 to 15.

<4> The ink jet textile printing ink according to any one of <1> to <3>, in which the coloring material is a reactive dye.

<5> The ink jet textile printing ink according to any one of <1> to <4>, in which the coloring material is at least one selected from the group consisting of

C. I. Reactive Black 5,

C. I. Reactive Black 39,

C. I. Reactive Brown 11,

C. I. Reactive Orange 12,

C. I. Reactive Orange 13,

C. I. Reactive Blue 49,

C. I. Reactive Blue 72,

C. I. Reactive Red 245,

C. I. Reactive Yellow 85, and

C. I. Reactive Yellow 95.

<6> The ink jet textile printing ink according to any one of <1> to <5>, in which the solvent A is at least one selected from the group consisting of a compound represented by Formula (1), glycerin, and 2-pyrrolidone.

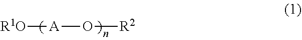

In Formula (1), A represents an ethylene group or a propylene group, le and R² each independently represent a hydrogen atom or an alkyl group, and n is 0 to 3.

In a case where n is 0, at least one of R¹ or R² is an alkyl group.

<7> The ink jet textile printing ink according to any one of <1> to <6>, in which a content of the coloring material with respect to the total amount of the ink jet textile printing ink is 10 mass % or greater.

<8> An ink jet textile printing method having: a step of applying the ink jet textile printing ink according to any one of <1> to <7> to a fabric by an ink jet method; and a step of heat-treating the fabric on which the ink jet textile printing ink is applied.

According to the present disclosure, an ink jet textile printing method which is excellent in jetting stability of an ink from an ink jet head, drying properties of an image recorded on a fabric, and circulation suitability of the ink, and an ink jet textile printing ink with which the ink jet textile printing method can be performed are provided.

### DESCRIPTION OF THE PREFERRED EMBODIMENTS

In this specification, a numerical range expressed using “to” means a range including numerical values before and after “to” as a minimum value and a maximum value.

In numerical ranges described in a stepwise manner in this specification, an upper limit or a lower limit described in a certain numerical range may be replaced with an upper limit or a lower limit in another numerical range described in a stepwise manner. In addition, in a numerical range described in this specification, an upper limit or a lower limit described in a certain numerical range may be replaced with a value shown in an example.

In this specification, regarding the amount of each component in a composition, in a case where there are a plurality of substances corresponding to the component in the composition, the amount means a total amount of the plurality of substances present in the composition, unless otherwise specified.

In this specification, a combination of two or more preferable aspects is a more preferable aspect.

In this specification, the term “step” includes not only an independent step but also cases where it cannot be clearly distinguished from other steps, so long as the desired effect of the step can be achieved.

[Ink Jet Textile Printing Ink]

An ink jet textile printing ink according to an embodiment of the present disclosure contains:

water;

a coloring material;

a polymer X which is a water-soluble polymer with a weight-average molecular weight of 6,000 to 35,000, including at least one selected from the group consisting of a structural unit derived from alkylene glycol, a structural unit derived from vinyl alcohol, a structural unit derived from vinyl acetate, and a structural unit derived from vinylpyrrolidone; and

a solvent A which is a water-soluble organic solvent with a molecular weight of 160 or less,

a ratio of the solvent A in all water-soluble organic solvents contained in the ink jet textile printing ink is 70 mass % or greater,

a content of the polymer X with respect to a total amount of the ink jet textile printing ink is 0.9 mass % to 6.0 mass %, and

a mass ratio of a content of the solvent A to the content of the polymer X is 7.0 to 50.

Hereinafter, the ink jet textile printing ink is also simply referred to as “ink”.

With the ink according to the embodiment of the present disclosure, an ink jet textile printing method which is excellent in jetting stability of an ink from an ink jet head, drying properties of an image recorded on a fabric, and circulation suitability of the ink can be performed.

The reason why such an effect is obtained is presumed as follows.

In order to improve the jetting stability of the ink from the ink jet head, increasing the viscosity of the ink (that is, thickening the ink) is effective.

As a method for thickening the ink, containing a large amount of a water-soluble organic solvent in the ink can be considered. However, in a case where this method is employed, the drying properties of the image recorded on a fabric may be lowered.

In addition, in a case where a large amount of a water-soluble organic solvent is contained in the ink, the coloring material tends to precipitate in the ink with the lapse of time, and as a result, the circulation suitability of the ink between the ink tank and the ink jet head may decrease (for example, filter clogging may occur during circulation).

In the present disclosure, the ink contains a polymer X which is a water-soluble polymer having a specific structure with a specific weight-average molecular weight (Mw).

Furthermore,

a ratio of the solvent A in all water-soluble organic solvents contained in the ink is adjusted to 70 mass % or greater,

a content of the polymer X with respect to a total amount of the ink is adjusted to 0.9 mass % to 6.0 mass %, and

a mass ratio of a content of the solvent A to the content of the polymer X (hereinafter, also referred to as a content mass ratio [solvent A/polymer X]) is adjusted to 7.0 to 50.

In the ink according to the embodiment of the present disclosure, the jetting stability of the ink is improved by the effect of the thickening of the ink by the polymer X. Furthermore, by thickening the ink with the polymer X, the precipitation of the coloring material in the ink with the lapse of time is suppressed as compared with a case where the ink contains a large amount of a water-soluble organic solvent to thicken the ink, and as a result, the circulation suitability of the ink is improved.

Furthermore, the drying properties of the image is improved since the ratio of the solvent A is 70 mass % or greater.

Hereinafter, the components which may be contained in the ink according to the embodiment of the present disclosure will be described.

<Water>

The ink according to the embodiment of the present disclosure contains water.

The content of the water with respect to the total amount of the ink according to the embodiment of the present disclosure is preferably 25 mass % or greater, more preferably 30 mass % or greater, and even more preferably 35 mass % or greater.

Although depending on the amount of other components, the upper limit of the content of the water with respect to the total amount of the ink according to the embodiment of the present disclosure is, for example, 60 mass %, and is preferably 55 mass % with respect to the total amount of the ink.

<Coloring Material>

The ink according to the embodiment of the present disclosure contains at least one type of coloring material.

Examples of the coloring material include pigments and dyes.

The coloring material is preferably a dye from the viewpoint of the density of an image to be recorded.

Examples of the dye include reactive dyes, oil-soluble dyes, dispersible dyes, and vat dyeing dyes.

Reactive dyes, oil-soluble dyes, dispersible dyes, and vat dyeing dyes are called using the words “Reactive”, “Solvent”, “Disperse”, and “Vat” in “C. I.” (color index), respectively.

The dye is more preferably a reactive dye from the viewpoint of the density of an image to be recorded.

The reactive dye is even more preferably at least one selected from the group consisting of

C. I. Reactive Black 5,

C. I. Reactive Black 39,

C. I. Reactive Brown 11,

C. I. Reactive Orange 12,

C. I. Reactive Orange 13,

C. I. Reactive Blue 49,

C. I. Reactive Blue 72,

C. I. Reactive Red 245,

C. I. Reactive Yellow 85, and

C. I. Reactive Yellow 95.

The content of the coloring material with respect to the total amount of the ink according to the embodiment of the present disclosure is preferably 8 mass % or greater, more preferably 9 mass % or greater, even more preferably 10 mass % or greater, and much more preferably 11 mass % or greater from the viewpoint of the density of an image to be recorded.

The content of the coloring material with respect to the total amount of the ink according to the embodiment of the present disclosure is preferably 40% mass % or less, more preferably 35 mass % or less, even more preferably 30 mass % or less, and much more preferably 25 mass % or less.

<Polymer X>

The ink according to the embodiment of the present disclosure contains at least one type of polymer X which is a water-soluble polymer with a weight-average molecular weight of 6,000 to 35,000, including at least one selected from the group consisting of a structural unit derived from alkylene glycol, a structural unit derived from vinyl alcohol, a structural unit derived from vinyl acetate, and a structural unit derived from vinylpyrrolidone.

The polymer X is a water-soluble polymer.

The water-soluble properties are a prerequisite for the effect of the polymer X (that is, the effect of thickening the ink, thereby improving the jetting stability and the circulation suitability, and the same hereinafter).

In the present disclosure, the “water-soluble” means that the amount dissolved in 100 g of distilled water at 25° C. is greater than 1 g.

The amount of the polymer X which is a water-soluble polymer dissolved is preferably 5 g or greater, more preferably 10 g or greater, and even more preferably 20 g or greater.

The weight-average molecular weight (Mw) of the polymer X is 6,000 to 35,000.

In a case where the Mw of the polymer X is 6,000 to 35,000, the effect of the polymer X (that is, the effect of thickening the ink) is effectively exhibited.

The Mw of the polymer X is preferably 6,000 to 30,000, more preferably 8,000 to 30,000, and even more preferably 10,000 to 25,000.

In the present disclosure, the weight-average molecular weight (Mw) can be measured by a gel permeation chromatograph (GPC). The specific measurement method is as follows. The product name “HLC-8020GPC” manufactured by TOSOH CORPORATION is used as the GPC. In addition, three columns of the product name “TSKgel, SuperMultipore HZ-H” (4.6 mmID×15 cm) manufactured by TOSOH CORPORATION, and tetrahydrofuran (THF) as an eluent are used. The measurement is performed under conditions of a sample concentration of 0.45 mass %, a flow rate of 0.35 ml/min, a sample injection volume of 10 μl, and a measurement temperature of 40° C. using a RI (differential refractive index) detector. A calibration curve is made using 8 samples of the product name “TSK standard polystyrene” manufactured by TOSOH CORPORATION: “F-40”, “F-20”, “F-4”, “F-1”, “A-5000”, “A-2500”, “A-1000”, and “n-propylbenzene” as standard samples.

The polymer X contains at least one selected from the group consisting of a structural unit derived from alkylene glycol, a structural unit derived from vinyl alcohol, a structural unit derived from vinyl acetate, and a structural unit derived from vinylpyrrolidone.

Here, the structural unit derived from alkylene glycol, the structural unit derived from vinyl alcohol, the structural unit derived from vinyl acetate, and the structural unit derived from vinylpyrrolidone mean structural units formed by the polymerization of alkylene glycol, vinyl alcohol, vinyl acetate, and vinylpyrrolidone as monomers, respectively.

As the alkylene glycol, ethylene glycol or propylene glycol is preferable.

The polymer X may be a homopolymer of one type of monomer or a copolymer of two or more types of monomers.

The copolymer may be a random copolymer or a block copolymer.

As the polymer X,

a polymer (that is, homopolymer or copolymer) obtained by polymerizing at least one selected from the group consisting of ethylene glycol, propylene glycol, vinyl alcohol, vinyl acetate, and vinylpyrrolidone is preferable, and

a copolymer of polyethylene glycol, polypropylene glycol, or ethylene glycol and propylene glycol, a copolymer of polyvinyl alcohol, polyvinyl acetate, or vinyl alcohol and polyvinyl acetate, or polyvinylpyrrolidone is more preferable.

The content of the polymer X with respect to the total amount of the ink according to the embodiment of the present disclosure is 0.9 mass % to 6.0 mass %.

In a case where the content of the polymer X is within the above range, the effect of improving the jetting stability of the ink and the effect of improving the circulation suitability of the ink are achieved.

The content of the polymer X is preferably 0.9 mass % to 5.0 mass %, more preferably 1.0 mass % to 4.0 mass %, and even more preferably 1.0 mass % to 3.5 mass %.

In the ink according to the embodiment of the present disclosure, the mass ratio of the content of the solvent A to the content of the polymer X (hereinafter, also referred to as “content mass ratio [solvent A/polymer X]”) is 7.0 to 50.

In a case where the content mass ratio [solvent A/polymer X] is within the above range, the effect of improving the jetting stability of the ink, the effect of improving the drying properties of the image, and the effect of improving the circulation suitability of the ink are achieved.

The content mass ratio [solvent A/polymer X] is preferably 7.5 to 45, and more preferably 7.5 to 40.

In the ink according to the embodiment of the present disclosure, the mass ratio of the content of the coloring material to the content of the polymer X (hereinafter, also referred to as “content mass ratio [coloring material/polymer X]”) is preferably 2.5 to 15.

In a case where the content mass ratio [coloring material/polymer X] is within the above range, the effect of improving the jetting stability of the ink, the effect of improving the drying properties of the image, and the effect of improving the circulation suitability of the ink are achieved.

The content mass ratio [coloring material/polymer X] is more preferably 3.0 to 14.

<Solvent A>

The ink according to the embodiment of the present disclosure contains at least one type of solvent A which is a water-soluble organic solvent with a molecular weight of 160 or less.

The solvent A is a water-soluble organic solvent, that is, an organic solvent of which the amount dissolved in 100 g of distilled water at 25° C. is greater than 1 g, and is a water-soluble organic solvent with a molecular weight of 160 or less.

The amount of the solvent A dissolved is preferably 5 g or greater, more preferably 10 g or greater, and even more preferably 20 g or greater.

The solvent A is a water-soluble organic solvent with a molecular weight of 160 or less.

The ink according to the embodiment of the present disclosure may or may not contain an organic solvent (for example, a water-soluble organic solvent with a molecular weight of more than 160) other than the solvent A.

The solvent A is particularly preferably at least one selected from the group consisting of a compound represented by Formula (1), glycerin, and 2-pyrrolidone.

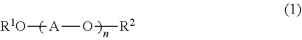

In Formula (1), A represents an ethylene group or a propylene group, R¹ and R² each independently represent a hydrogen atom or an alkyl group, and n is 0 to 3.

In a case where n is 0, at least one of R¹ or R² is an alkyl group.

In Formula (1), the number of carbon atoms of the alkyl group represented by R¹ is preferably 1 to 4, more preferably 1 to 3, and even more preferably 1 or 2.

In Formula (1), the number of carbon atoms of the alkyl group represented by R² is preferably 1 to 4, more preferably 1 to 3, and even more preferably 1 or 2.

In Formula (1), n is preferably 1 to 3.

Specific examples of the solvent A are as follows, but the solvent A is not limited to the following specific examples.
Triethylene Glycol (molecular weight: 150)
2-Pyrrolidone (molecular weight: 85)
Glycerin (molecular weight: 92)
Ethylene Glycol (molecular weight: 62)
Propylene Glycol (molecular weight: 76)
Diethylene Glycol Dimethyl Ether (molecular weight: 134)
Isopropyl Alcohol (molecular weight: 60)
Dipropylene Glycol (molecular weight: 134)
Diethylene Glycol (molecular weight: 106)
Diethylene Glycol Monomethyl Ether (molecular weight: 120)
Diethylene Glycol Monoethyl Ether (molecular weight: 134)
1,3-Butanediol (molecular weight: 90)
1,5-Pentanediol (molecular weight: 104)
1,2-Hexanediol (molecular weight: 118)

The ratio of the solvent A in all water-soluble organic solvents contained in the ink according to the embodiment of the present disclosure is 70 mass % or greater.

Accordingly, the effect of improving the drying properties of the image is achieved.

From the viewpoint of a further improvement in drying properties of the image, the ratio of the solvent A is preferably 80 mass % or greater, and more preferably 90 mass % or greater.

The upper limit of the ratio of the solvent A is not particularly limited, and may be 100 mass % or less than 100 mass %.

The content of the solvent A with respect to the total amount of the ink according to the embodiment of the present disclosure is preferably 10 mass % to 50 mass %, more preferably 15 mass % to 45 mass %, and even more preferably 20 mass % to 40 mass %.

In a case where the content of the solvent A is 10 mass %, the drying properties of the image are further improved.

In a case where the content of the solvent A is 50 mass % or less, the jetting stability and the circulation suitability of the ink are further improved.

Next, specific examples of the organic solvent other than the solvent A are as follows, but the organic solvent other than the solvent A is not limited to the following specific examples.
Tripropylene Glycol (molecular weight: 192)
Tetraethyl ene Glycol (molecular weight: 194)

<Solid Wetting Agent>

The ink according to the embodiment of the present disclosure may contain at least one type of solid wetting agent.

As the solid wetting agent, urea or a urea derivative is preferable.

Examples of the urea derivative include 1,3-dimethylurea, ethylene urea, and N-propyl urea.

The content of the solid wetting agent with respect to the total amount of the ink according to the embodiment of the present disclosure is preferably 1 mass % to 30 mass %, more preferably 3 mass % to 15 mass %, and even more preferably 5 mass % to 10 mass %.

<Surfactant>

The ink according to the embodiment of the present disclosure may contain at least one type of surfactant.

Examples of the surfactant include cationic surfactants, anionic surfactants, amphoteric surfactants, and nonionic surfactants.

Examples of the cationic surfactants include aliphatic amine salts, aliphatic quaternary ammonium salts, benzalkonium salts, benzethonium chloride, pyridinium salts, and imidazolinium salts.

Examples of the anionic surfactants include fatty acid soap (such as sodium oleate), N-acylglutamates, alkyl sulfonates, alkyl benzene sulfonates, alkyl sulfoacetate, sulfated oil, higher alcohol sulfuric ester salts, and alkyl phosphoric ester salts.

Examples of the amphoteric surfactants include carboxybetaine types, sulfobetaine types, aminocarboxylates, and imidazolinium betaines. Amine oxide types such as N,N-dimethyl-N-alkylamine oxides are also included as suitable examples.

Examples of the nonionic surfactants include polyoxyethylene alkyl ethers, polyoxyethylene lanolin derivatives, polyoxyethylene polyoxypropylene alkyl ethers, polyoxyethylene glycerin fatty acid esters, polyethylene glycol fatty acid esters, polyglycerol fatty acid esters, sorbitan fatty acid esters, propylene glycol fatty acid esters, and acetylene glycol-based surfactants.

As the surfactant, those described as examples of the surfactant in JP1984-157636A (JP-S59-157636A), pages 37 to 38, and Research Disclosure No. 308119 (1989) can also be used.

As the acetylene glycol-based surfactant, compounds represented by Formula (II) are preferable.

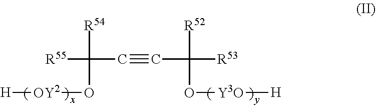

In Formula (II), R⁵², R⁵³, R⁵⁴, and R⁵⁵ each independently represent a hydrogen atom or a linear, branched, or cyclic alkyl group having 1 to 8 carbon atoms. Y² and Y³ each independently represent an alkylene group having 2 to 6 carbon atoms. x and y represent an average addition molar number, and satisfy 1≤x+y≤85.

Examples of the linear, branched, or cyclic alkyl group having 1 to 8 carbon atoms, represented by R⁵² and R⁵⁴, include a methyl group, an ethyl group, a propyl group, an isopropyl group, a butyl group, an isobutyl group, a 2-butyl group, a t-butyl group, a hexyl group, a cyclohexyl group, and an octyl group.

As R⁵² and R⁵⁴, a linear, branched or cyclic alkyl group having 1 to 8 carbon atoms is preferable, an alkyl group having 1 to 3 carbon atoms is more preferable, and a methyl group is most preferable.

In addition, examples of the linear, branched, or cyclic alkyl group having 1 to 8 carbon atoms, represented by R⁵³ and R⁵⁵, include a methyl group, an ethyl group, a propyl group, an isopropyl group, a butyl group, an isobutyl group, a 2-butyl group, a t-butyl group, a hexyl group, a cyclohexyl group, and an octyl group.

As R⁵³ and R⁵⁵, a linear, branched or cyclic alkyl group having 1 to 8 carbon atoms is preferable, and an isobutyl group is particularly preferable.

x and y represent an average addition molar number.

The sum of x and y is 1 to 85 (1≤x+y≤85), preferably 3 to 50, more preferably 3 to 30, and even more preferably 5 to 30.

In a case where the sum of x and y is 3 or greater, the solubility is further improved. It is preferable that the sum of x and y is 30 or less from the viewpoint of jetting stability since the effect of reducing the surface tension and improving the wettability can be more effectively obtained.

Y² and Y³ each independently represent an alkylene group having 2 to 6 carbon atoms, more preferably an alkylene group having 2 to 4 carbon atoms, even more preferably an alkylene group having 2 or 3 carbon atoms, and particularly preferably an alkylene group having 2 carbon atoms (ethylene group).

That is, among the compounds represented by Formula (II), compounds represented by Formula (II′) are more preferable.

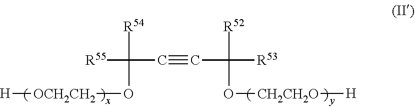

In Formula (II′), R⁵², R⁵³, R⁵⁴, R⁵⁵, x, and y are the same as R⁵², R⁵³, R⁵⁴, R⁵⁵, x, and y in Formula (II), respectively, and their preferable ranges are also the same.

Examples of the compounds represented by Formula (II) include alkylene oxide adducts (preferably ethylene oxide adducts) of 2,4,7,9-tetramethyl-5-decyne-4,7-diol, 3,6-dimethyl-4-octyne-3,6-diol, 2,5,8,11-tetramethyl-6-dodecyn-5,8-diol, and 2,5-dimethyl-3-hexyne-2,5-diol. Ethylene oxide adducts (3≤x+y≤30, more preferably 5≤x+y≤30) of 2,4,7,9-tetramethyl-5-decyne-4,7-diol are particularly preferable.

The compounds represented by Formula (II) can be used alone or in combination with various additives.

As the acetylene glycol-based surfactant (for example, the compound represented by Formula (II)), commercially available products on the market may be used.

Examples of the commercially available products include;

SURFYNOL series (such as SURFYNOL 420, SURFYNOL 440, SURFYNOL 465, and SURFYNOL 485) manufactured by Evonik Industries AG;

OLFINE series (such as OLFINE E1010 and OLFINE E1020) manufactured by Nissin Chemical Industry Co., Ltd.;

DYNOL series (such as DYNOL 604) manufactured by Nissin Chemical Industry Co., Ltd.; and

ACETYRENOL manufactured by Kawaken Fine Chemicals Co., Ltd.

In addition, the acetylene glycol-based surfactant is also provided from The Dow Chemical Company, GENERAL ANILINE, and the like.

The content of the surfactant with respect to the total amount of the ink according to the embodiment of the present disclosure is preferably 0.01 mass % to 5 mass %, and more preferably 0.1 mass % to 3 mass %.

<Other Components>

The ink according to the embodiment of the present disclosure may contain a component other than the above-described components.

Examples of other components include various additives such as a preservative and wax.

Regarding other components, the description in WO2017/131107A may be referred to.

<Viscosity of Ink>

The viscosity of the ink according to the embodiment of the present disclosure is preferably 8 mPa·s to 16 mPa·s, more preferably 8 mPa·s to 14 mPa·s, and even more preferably 9 mPa s to 12 mPa s from the viewpoint of jetting stability of the ink.

Here, the viscosity means a viscosity at 25° C.

The viscosity can be measured by using a viscometer, for example, a viscometer “VISCOMETER TV-22 (product name) (manufactured by TOKI SANGYO CO., LTD.)”.

<Surface Tension of Ink>

The surface tension of the ink according to the embodiment of the present disclosure is preferably 20 mN/m to 70 mN/m, and more preferably 25 mN/m to 60 mN/m.

Here, the surface tension means a value measured at 25° C.

The surface tension can be measured by using a surface tensiometer, for example, an “automatic surface tensiometer CBVP-Z (product name) (manufactured by Kyowa Interface Science Co., Ltd.)”.

[Ink Jet Textile Printing Method]

The ink according to the embodiment of the present disclosure can be used for image recording on any base material, and is particularly suitable for image recording on a fabric.

Examples of the image recording on a fabric include the following ink jet textile printing method A.

The ink jet textile printing method A has

a step of applying the ink according to the embodiment of the present disclosure to a fabric by an ink jet method (hereinafter, also referred to as “ink applying step”) and

a step of heat-treating the fabric on which the ink is applied (hereinafter, also referred to as “heat treatment step”).

The ink jet textile printing method A is excellent in jetting stability of the ink, drying properties of an image recorded on a fabric, and circulation suitability of the ink.

Specific examples of the fabric will be described later.

The ink jet textile printing method A does not require a transfer step, a printing paste applying step, or the like, which may be provided in a general textile printing method.

In addition, the ink jet textile printing method A also does not require a steam treatment step (that is, a step of fixing an image by a steam treatment) which may be provided in a general ink jet textile printing method. In a general ink jet textile printing method, particularly, the density of an image may be secured by the steam treatment step.

In the ink jet textile printing method A, an image with an excellent density can be recorded on a fabric even in a case where the steam treatment step is omitted.

In the ink jet textile printing method A, the fabric to be subjected to image recording may be a fabric pretreated with an aqueous pretreatment liquid containing an aggregating agent.

In a case where the fabric to be subjected to image recording is a pretreated fabric, the density of the image is further improved.

The pretreated fabric may be previously prepared prior to the implementation of the ink jet textile printing method A.

In addition, the ink jet textile printing method A may have a pretreatment step of obtaining a pretreated fabric by applying an aqueous pretreatment liquid containing an aggregating agent to a fabric before the ink applying step.

Hereinafter, the respective steps which can be included in the ink jet textile printing method A will be described.

(Pretreatment Step)

The pretreatment step is a step of obtaining a pretreated fabric by applying an aqueous pretreatment liquid containing an aggregating agent to a fabric.

The method of applying an aqueous pretreatment liquid to the fabric is not particularly limited, and examples thereof include a coating method, a padding method, an ink jet method, a spraying method, and a screen printing method.

The aggregating agent contained in the aqueous pretreatment liquid is preferably at least one selected from an organic acid, a polyvalent metal salt, or a cationic compound, and more preferably at least one selected from a polyvalent metal salt or a cationic compound.

—Polyvalent Metal Salt—The polyvalent metal salt is a compound composed of a di- or higher-valent metal ion and an anion.

Specific examples thereof include calcium chloride, calcium nitrate, calcium sulfate, calcium acetate, calcium hydroxide, calcium carbonate, magnesium chloride, magnesium acetate, magnesium sulfate, magnesium carbonate, barium sulfate, barium chloride, zinc sulfide, zinc carbonate, and copper nitrate.

—Cationic Compound—

The cationic compound is not particularly limited, and may be a low-molecular-weight compound or a polymer compound.

Examples of the low-molecular-weight cationic compound include (2-hydroxyethyl)trimethylammonium chloride, benzoylcholine chloride, benzyltriethylammonium chloride, trimethylacetohydrazideammonium chloride, 1-butyl-1-methylpyrrolidinium chloride, 3-hydroxy-4-(trimethylammonio)butyrate hydrochloride, glycidyltrimethylammonium chloride, L-carnitine hydrochloride, and alkylcarbonyloxyethyltrimethylammonium chloride having 6 to 30 carbon atoms.

Examples of the cationic polymer compound include water-soluble cationic polymers which are positively charged in water, such as polyallylamine or derivatives thereof, amine-epihalohydrin copolymers, or other quaternary ammonium salt type cationic polymers. In some cases, a water-dispersible cationic polymer can also be used.

The low-molecular-weight cationic compound is preferable from the viewpoint of a further improvement in the washing resistance of an image in a printed textile product.

The molecular weight of the low-molecular-weight cationic compound is preferably 1,000 or less, and more preferably 500 or less.

The aggregating agents may be used alone or in combination of two or more types thereof.

The aqueous pretreatment liquid contains, for example, the above-described aggregating agent and water.

The aqueous pretreatment liquid may further contain other components such as an aqueous organic solvent and a surfactant.

As components which can be contained in the aqueous pretreatment liquid, the components which can be contained in the ink can be appropriately referred to.

(Ink Applying Step)

The ink applying step is a step of applying the ink according to the embodiment of the present disclosure to a fabric by an ink jet method.

In the present disclosure, the fabric on which the ink is applied by the ink applying step may be referred to as a colored fabric.

The application of the ink in the ink applying step can be performed using a known ink jet recording device.

The ink jet recording device is not particularly limited, and a known ink jet recording device capable of achieving a desired resolution can be optionally selected and used.

Examples of the ink jet recording device include a device including an ink supply system, a temperature sensor, and a heating unit.

The ink supply system includes, for example, a source tank containing the ink according to the embodiment of the present disclosure, a supply pipe, an ink supply tank immediately before the ink jet head, a filter, and a piezo ink jet head. The piezo ink jet head can be driven so as to eject multi-size dots of preferably 1 pL (picoliter) to 100 pL, and more preferably 8 pL to 30 pL with a resolution of preferably 320 dpi×320 dpi to 4,000 dpi×4,000 dpi, more preferably 400 dpi×400 dpi to 1,600 dpi×1,600 dpi, and even more preferably 720 dpi×720 dpi. The dpi (dot per inch) indicates the number of dots per 2.54 cm (1 inch).

<Heat Treatment Step>

The heat treatment step is a step of heat-treating the fabric on which the ink is applied (that is, colored fabric).

By the heat treatment in this step, an image having excellent optical density is obtained.

In the present disclosure, the heat-treated colored fabric may be referred to as a printed textile product.

The heat treatment temperature (temperature of the ink applied to the fabric) in the heat treatment step is preferably 100° C. to 220° C., and more preferably 130° C. to 200° C.

The heat treatment time in the heat treatment step is preferably 20 seconds to 300 seconds, more preferably 30 seconds to 240 seconds, and even more preferably 40 seconds to 180 seconds.

The heat treatment in the heat treatment step may be a steam treatment known in the ink jet textile printing. However, from the viewpoint of simplification of the step, a heat treatment other than the steam treatment is preferable.

The heat treatment other than the steam treatment is preferably a heat treatment in which the fabric on which the ink is applied (that is, colored fabric) is heat-pressed. In the heat treatment of this aspect, the ink in the colored fabric can be heat-treated by heat-pressing the colored fabric.

The heat-pressing can be performed using a known heat press machine.

As described above, even in a case where the steam treatment is omitted, an image having excellent optical density can be formed on a fabric by a heat treatment other than the steam treatment in the ink jet textile printing method A.

The ink jet textile printing method A may include a step other than the above steps.

Examples of other steps include known steps in the ink jet textile printing method, such as a posttreatment step of posttreating the colored fabric after the heat treatment step using a posttreatment agent.

<Fabric>

The ink jet textile printing method A can be applied to various types of fabrics.

Examples of the fiber type of the fabric include synthetic fibers such as nylon, polyester, and acrylonitrile; semi-synthetic fibers such as acetate and rayon; natural fibers such as cotton, silk, and wool; and mixed fibers consisting of two or more selected from the group consisting of the synthetic fibers, the semi-synthetic fibers, and the natural fibers.

The fiber type of the fabric is preferably at least one selected from cotton or polyester.

Examples of the aspect of the fabric include woven fabrics, knitted fabrics, and nonwoven fabrics.

The fabric may be a fabric for a fabric product.

Examples of the fabric product include clothing items (T-shirts, tracksuits, jerseys, pants, sweatsuits, dresses, and blouses), bedding, and handkerchiefs.

[Other Image Recording Methods]

Needless to say, the ink according to the embodiment of the present disclosure may be used for an image recording method other than the ink jet textile printing method A.

Examples of the image recording method other than the ink jet textile printing method A include a method in which the fabric in the ink jet textile printing method A is changed to a base material other than the fabric.

Examples of the base material other than the fabric include a plastic base material.

Examples of the plastic of the plastic base material include a polyvinyl chloride (PVC) resin, cellulose diacetate, cellulose triacetate, cellulose propionate, cellulose butyrate, cellulose acetate butyrate, cellulose nitrate, polyethylene terephthalate (PET), polyethylene (PE), polystyrene (PS), polypropylene (PP), polycarbonate (PC), polyvinyl acetal, and an acrylic resin.

The plastic base material may be corona-treated.

With the ink according to the embodiment of the present disclosure, an image having excellent adhesiveness can be formed not only on a general plastic base material such as a PET base material, but also on a base material in which it is difficult to secure adhesiveness to an image in image recording by an aqueous ink.

Examples of the base material in which it is difficult to secure adhesiveness to an image in image recording by an aqueous ink include a hydrophobic base material having no polar group.

Examples of the hydrophobic base material having no polar group include a PS base material, a corona-treated PP base material (may be referred to as “corona PP”), a PE base material, and a PE-laminated paper base material.

### EXAMPLES

Hereinafter, examples of the present disclosure will be described. The present disclosure is not limited to the following examples.

### Examples 1 to 25 and Comparative Examples 1 and 11

<Preparation of Ink>

Inks were prepared by mixing respective components shown in Tables 1 to 3.

The viscosity of each of the prepared inks at 25° C. was measured using a viscometer VISCOMETER TV-22 (manufactured by TOKI SANGYO CO., LTD.).

The results are shown in Tables 1 to 3.

<Preparation of Pretreatment Liquid>

Components of the following composition were mixed to obtain a pretreatment liquid.

—Composition of Pretreatment Liquid—
Water (66.3 parts by mass)
Urea (20 parts by mass)
Sodium Carbonate (12 parts by mass)
Sodium Alginate (1.7 parts by mass)

<Ink Jet Textile Printing>

A fabric was pretreated using the pretreatment liquid, and the ink was applied to the fabric after the pretreatment by an ink jet method to obtain a colored fabric. The obtained colored fabric was heat-treated, and thus a printed textile product was obtained.

The details thereof are as follows.

(Pretreatment of Fabric)

As a fabric, an elongated (15 cm×4 cm) fabric of 100% cotton (product name “Cotton D5005”, manufactured by Akahori Sangyo Corporation) was prepared.

The pretreatment liquid was applied to the fabric by a padding method. The amount of the pretreatment liquid applied (that is, wet application amount) was 60 mass % with respect to the mass of the base material.

The fabric on which the pretreatment liquid was applied was dried overnight under room temperature conditions, and thus a pretreated fabric (that is, fabric after the pretreatment) was obtained.

(Application of Ink)

An ink jet recording device for applying the ink was prepared.

The ink jet recording device includes

a movable stage on which the fabric after the pretreatment is placed,

an ink jet head (product name “StarFire SG-1024SA”, manufactured by Fujifilm Dimatix),

an ink tank connected to the ink jet head, and

an ink circulation pump which circulates the ink between the ink tank and the ink jet head.

The ink jet recording device includes, in an ink circulation path, a filter for filtering the ink supplied to the ink jet head and a pressure sensor for measuring the pressure of the ink which is circulated.

As the filter, a filter (NY025500 manufactured by Membrane Solutions LLC) made of polytetrafluoroethylene (PTFE) and having a diameter of 25 mm and a pore diameter of 5 μm was used.

In the ink jet recording device, the ink jet head was disposed so that nozzles were arranged in a direction orthogonal to the moving direction of the stage.

The ink tank of the ink jet recording device was filled with the ink, and the fabric pretreated as above was fixed on the stage of the ink jet recording device.

The ink circulation pump was operated to circulate the ink between the ink tank and the ink jet head. In this state, by jetting the ink from the ink jet head while moving the stage, the ink was applied to the fabric after the pretreatment in a 3-pass scanning mode at 11 g/m², and a solid image was recorded. Accordingly, a colored fabric was obtained.

As ink jetting conditions, the liquid droplet volume deposited was 15 pL, the jetting frequency was 10 kHz, and the resolution was 400 dpi×400 dpi.

(Heat Treatment (Heat-Pressing))

The obtained colored fabric was heat-treated under conditions of 160° C. and 120 seconds using a heat press machine (desktop automatic flat press machine AF-54TEN, manufactured by Asahi Garment Machinery Co., Ltd.), and a printed textile product was obtained.

<Evaluation>

The following evaluation was performed on the inks.

The results are shown in Tables 1 to 3.

(Jetting Stability of Ink)

The solid image of the printed textile product obtained by the ink jet textile printing was visually observed (the area to be observed was an area having a length of 150 mm and a width of 46 mm), and the jetting stability of the ink was evaluated according to the following evaluation standards.

In the following evaluation standards, the most excellent jetting stability of the ink is represented by level A.

In the following evaluation standards, “dark streaks” mean streaks which are visible in a case where the streaks are visually observed from a position 1 m away from the streaks, and “thin streaks” mean streaks which are not visible in a case where the streaks are visually observed from a position 1 m away from the streaks, but are visible in a case where the streaks are observed from a closer position.

—Standards for Evaluation of Jetting Stability of Ink—

A: The number of thin streaks is one or less, and the number of dark streaks is zero.

B: The number of thin streaks is two or more, and the number of dark streaks is zero.

C: The number of dark streaks is one.

D: The number of dark streaks is two or more.

(Drying Properties of Image)

The colored fabric (that is, the fabric on which the ink was applied) obtained by the ink jet textile printing was heated for 1 minute on a hot plate at 60° C. After heating, the solid image of the colored fabric was brought into contact with the fabric before the pretreatment for 10 seconds with a force of 1N applied. Next, the fabric was separated from the colored fabric and visually observed to confirm whether the image was transferred to the fabric.

Next, the same operations as the above-described series of operations were performed, except that the contact time between the fabric and the solid image was changed to 1 second.

Based on the confirmed results, the drying properties of the image were evaluated according to the following evaluation standards.

In the following evaluation standards, the most excellent drying properties of the image are represented by level A.

—Standards for Evaluation of Drying Properties of Image—

A: Image transfer is not shown in both a case where the contact time is 10 seconds and a case where the contact time is 1 second.

B: Image transfer is shown in a case where the contact time is 10 seconds, but image transfer is not shown in a case where the contact time is 1 second.

C: Image transfer is shown in a case where the contact time is 10 seconds, and slight image transfer is also shown in a case where the contact time is 1 second.

D: Image transfer is shown in a case where the contact time is 10 seconds, and image transfer is also shown in a case where the contact time is 1 second.

(Circulation Suitability of Ink)

Using the ink jet recording device, the circulation suitability of the ink was evaluated as follows.

The ink was circulated between the ink tank and the ink jet head by operating the ink circulation pump.

In this case, an initial pressure at the start of the circulation was adjusted to be less than 20 kPa, the upper limit of the pressure was set to 50 kPa, and the flow rate of the ink was adjusted in a range of 10 m/min to 12 m/min.

The pressure of the ink was measured every 10 minutes from the start of the ink circulation.

Based on the pressure of the ink at a time point of 60 minutes after the start of the circulation, the circulation suitability of the ink was evaluated according to the following evaluation standards.

In the following evaluation standards, the most excellent circulation suitability of the ink is represented by level A.

—Standards for Evaluation of Circulation Suitability of Ink—

AA: The pressure at a time point of 60 minutes after the start of the circulation was less than 15 kPa.

A: The pressure at a time point of 60 minutes after the start of the circulation was 15 kPa or greater and less than 20 kPa.

B: The pressure at a time point of 60 minutes after the start of the circulation was 20 kPa or greater and less than 30 kPa.

C: The pressure at a time point of 60 minutes after the start of the circulation was 30 kPa or greater and less than 50 kPa.

D: The pressure reached 50 kPa before a time point of 60 minutes after the start of the circulation.

(Image Density)

The optical density (optical density (OD) value) of the image of the printed textile product obtained in each of the examples and the comparative examples was measured using a colorimeter (Gretag Macbeth Spectrolino, manufactured by X-Rite, Inc.).

Next, a reference printed textile product was produced for each of the examples and the comparative examples in the same manner as in the ink jet textile printing, except that as the inks, TX120 and TX122 inks manufactured by Fujifilm Imaging Colorants, Inc. were used (specifically, the ink having a color corresponding to the color of the ink in each of the examples and the comparative examples was used).

The optical density of the image of each reference printed textile product was measured using a colorimeter (Gretag Macbeth Spectrolino, manufactured by X-Rite, Inc.).

A relative value (%) of the OD value of the printed textile product of each of the examples and the comparative examples in a case where the OD value of the corresponding reference printed textile product was set to 100% was obtained to evaluate the image density according to the following evaluation standards.

In the following evaluation standards, the most excellent image density is represented by level A.

A: The relative value of the OD value of the printed textile product was 80% or greater.

B: The relative value of the OD value of the printed textile product was 60% or greater and less than 80%.

C: The relative value of the OD value of the printed textile product was less than 60%.

TABLE 1

| | | | Example | Example | Example | Example | Example | Example | Example |
|---|---|---|---|---|---|---|---|---|---|
| | | | 1 | 2 | 3 | 4 | 5 | 6 | 7 |
| Ink | Coloring | Type | Reactive | Reactive | Reactive | Reactive | Reactive | Reactive | Reactive |
| | Material | | Black 39 | Red 245 | Orange 13 | Blue 72 | Red 245 | Yellow 95 | Blue 49 |
| | | Content | 9.0 | 14.0 | 10.5 | 11.5 | 14.0 | 11.0 | 16.0 |
| | | Type | Reactive | | | | | | |
| | | | Brown 11 | | | | | | |
| | | Content | 6.0 | | | | | | |
| | | Type | Reactive | | | | | | |
| | | | Orange 12 | | | | | | |
| | | Content | 3.0 | | | | | | |
| | | Total Content | 18.0 | 14.0 | 10.5 | 11.5 | 14.0 | 11.0 | 16.0 |
| | | of Coloring | | | | | | | |
| | | Materials | | | | | | | |
| | Solvent A | TriEG (150) | | | | | | | |
| | (the | 2-Py (85) | 5.0 | 5.0 | 5.0 | 5.0 | 5.0 | 5.0 | 5.0 |
| | numerical | GL (92) | | | | | | 4.0 | 5.0 |
| | value in the | EG (62) | 18.0 | 14.0 | 16.0 | 15.0 | 14.0 | 15.0 | 18.0 |
| | brackets | PG (76) | | | | | | | |
| | corresponds | DEGmME | | | | | | | |
| | to the | (148) | | | | | | | |
| | molecular | IPA (60) | | | | | | | |
| | weight) | DPG (134) | | 10.0 | 18.0 | 15.0 | 10.0 | 15.0 | |
| | Other | T riPG (192) | | | | | | | |
| | Solvents | | | | | | | | |
| | | TetraEG (194) | | | | | | | |
| | Polymer | Type | PEG20K | PE-108 | PEG20K | PEG20K | PEG20K | PEG20K | PEG20K |
| | X | Mw | 20000 | 17000 | 20000 | 20000 | 20000 | 20000 | 20000 |
| | | Content | 1.9 | 3.0 | 0.9 | 0.9 | 1.5 | 1.0 | 1.2 |
| | Additives | Urea | 10.0 | 10.0 | 5.0 | 8.0 | 7.0 | 10.0 | 9.0 |
| | | Surfynol 465 | 1.0 | | | | | | |
| | | Surfynol 440 | | 0.4 | 0.4 | 0.4 | 0.4 | 0.4 | 0.4 |
| | | proxcel GXL | 0.1 | 0.1 | 0.1 | 0.1 | 0.1 | 0.1 | 0.1 |
| | | DEAS | 1.0 | 1.0 | 0.5 | 0.5 | 0.5 | 0.5 | 0.5 |
| | Water | | remaining | remaining | remaining | remaining | remaining | remaining | remaining |
| | | | amount | amount | amount | amount | amount | amount | amount |
| | Viscosity (mPa · s) at 25° C. | | 10.3 | 12.0 | 10.4 | 10.5 | 10.8 | 10.9 | 10.7 |
| | Ratio (mass %) of Solvent A | | 100 | 100 | 100 | 100 | 100 | 100 | 100 |
| | in All Water-Soluble Organic | | | | | | | | |
| | Solvents | | | | | | | | |
| | Content Mass Ratio | | 12.1 | 9.7 | 43.3 | 38.9 | 19.3 | 39.0 | 23.3 |
| | [solvent A/polymer X] | | | | | | | | |
| | Content Mass Ratio | | 9.5 | 4.7 | 11.7 | 12.8 | 9.3 | 11.0 | 13.3 |
| | [coloring material/ | | | | | | | | |
| | polymer X] | | | | | | | | |
| Evaluation | Jetting Stability of Ink | | A | A | A | A | A | A | A |
| | Drying Properties of Image | | A | A | B | A | A | B | A |
| | Circulation Suitability of Ink | | A | AA | B | A | AA | B | AA |
| | Image Density | | A | A | A | A | A | A | A |
| | | | Example | Example | Example | Example | Example | Example | Example |
| | | | 8 | 9 | 10 | 11 | 12 | 13 | 14 |
| Ink | Coloring | Type | Reactive | Reactive | Disperse | Reactive | Reactive | Reactive | Reactive |
| | Material | | Black 5 | Yellow 85 | Yellow | Red 245 | Orange 13 | Red 245 | Red 245 |
| | | Content | 13.0 | 12.0 | 11.0 | 14.0 | 9.0 | 14.0 | 14.0 |
| | | Type | | | | | | | |
| | | Content | | | | | | | |
| | | Type | | | | | | | |
| | | Content | | | | | | | |
| | | Total Content | 13.0 | 12.0 | 11.0 | 14.0 | 9.0 | 14.0 | 14.0 |
| | | of Coloring | | | | | | | |
| | | Materials | | | | | | | |
| | Solvent A | TriEG (150) | | | | | | | |
| | (the | 2-Py (85) | 5.0 | 5.0 | 5.0 | 5.0 | 5.0 | 5.0 | 5.0 |
| | numerical | GL (92) | | 4.0 | 4.0 | | | | |
| | value in the | EG (62) | 14.0 | 15.0 | 15.0 | 14.0 | 16.0 | 14.0 | 14.0 |
| | brackets | PG (76) | | | | | | | |
| | corresponds | DEGmME | | | | | | | |
| | to the | (148) | | | | | | | |
| | molecular | IPA (60) | | | | | | | |
| | weight) | DPG (134) | 10.0 | 15.0 | 15.0 | 10.0 | 18.0 | 10.0 | 10.0 |
| | Other | T riPG (192) | | | | | | | |
| | Solvents | | | | | | | | |
| | | TetraEG (194) | | | | | | | |
| | Polymer | Type | PEG20K | PEG20K | PEG20K | PVP25K | PEG20K | PVP35K | PVA |
| | X | Mw | 20000 | 20000 | 20000 | 25000 | 20000 | 35000 | 22000 |
| | | Content | 2.2 | 1.0 | 1.0 | 1.0 | 0.9 | 1.0 | 1.0 |
| | Additives | Urea | 10.0 | 10.0 | 10.0 | 10.0 | 5.0 | 10.0 | 10.0 |
| | | Surfynol 465 | | | | | | | |
| | | Surfynol 440 | 0.4 | 0.4 | 0.4 | 0.4 | 0.4 | 0.4 | 0.4 |
| | | proxcel GXL | 0.1 | 0.1 | 0.1 | 0.1 | 0.1 | 0.1 | 0.1 |
| | | DEAS | 0.5 | 0.5 | 0.5 | 1.0 | 0.5 | 1.0 | 1.0 |

| | | | | | | | | |
|---|---|---|---|---|---|---|---|---|
| | Water | remaining | remaining | remaining | remaining | remaining | remaining | remaining |
| | | amount | amount | amount | amount | amount | amount | amount |
| | Viscosity (mPa · s) at 25° C. | 10.3 | 11.1 | 13.6 | 9.5 | 8.9 | 11.3 | 11.7 |
| | Ratio (mass %) of Solvent A | 100 | 100 | 100 | 100 | 100 | 100 | 100 |
| | in All Water-Soluble Organic | | | | | | | |
| | Solvents | | | | | | | |
| | Content Mass Ratio | 13.2 | 39.0 | 39.0 | 29.0 | 43.3 | 29.0 | 29.0 |
| | [solvent A/polymer X] | | | | | | | |
| | Content Mass Ratio | 5.9 | 12.0 | 11.0 | 14.0 | 10.0 | 14.0 | 14.0 |
| | [coloring material/ | | | | | | | |
| | polymer X] | | | | | | | |
| Evaluation | Jetting Stability of Ink | A | A | B | A | A | A | B |
| | Drying Properties of Image | A | B | B | A | B | A | B |
| | Circulation Suitability of Ink | AA | B | B | A | A | A | A |
| | Image Density | A | A | B | A | B | A | A |

TABLE 2

| | | | Example | Example | Example | Example | Example | Example |
|---|---|---|---|---|---|---|---|---|
| | | | 15 | 16 | 17 | 18 | 19 | 20 |
| Ink | Coloring | Type | Reactive | Reactive | Reactive | Reactive | Reactive | Reactive |
| | Material | | Black 39 | Black 39 | Black 39 | Black 39 | Black 39 | Black 39 |
| | | Content | 9.0 | 9.0 | 5.4 | 7.2 | 10.0 | 10.0 |
| | | Type | Reactive | Reactive | Reactive | Reactive | Reactive | Reactive |
| | | | Brown 11 | Brown 11 | Brown 11 | Brown 11 | Brown 11 | Brown 11 |
| | | Content | 6.0 | 6.0 | 3.6 | 4.8 | 5.8 | 5.8 |
| | | Type | Reactive | Reactive | Reactive | Reactive | Reactive | Reactive |
| | | | Orange 12 | Orange 12 | Orange 12 | Orange 12 | Orange 12 | Orange 12 |
| | | Content | 3.0 | 3.0 | 1.8 | 2.4 | 2.8 | 2.8 |
| | | Total Content | 18.0 | 18.0 | 10.8 | 14.4 | 18.6 | 18.6 |
| | | of Coloring | | | | | | |
| | | Materials | | | | | | |
| | Solvent A | TriEG (150) | | | | | | |
| | (the | 2-Py (85) | | | 5.0 | 5.0 | 5.0 | 5.0 |
| | numerical | GL (92) | | | | | | |
| | value in the | EG (62) | | | 18.0 | 18.0 | 18.0 | 18.0 |
| | brackets | PG (76) | | | | | | |
| | corresponds | DEGmME | 23.0 | | | | | |
| | to the | (148) | | | | | | |
| | molecular | IPA (60) | | 23.0 | | | | |
| | weight) | DPG (134) | | | | | | |
| | Other | TriPG (192) | | | | | | |
| | Solvents | TetraEG (194) | | | | | 3.0 | 8.0 |
| | Polymer | Type | PEG20K | PEG20K | PEG20K | PEG20K | PEG20K | PEG20K |
| | X | Mw | 20000 | 20000 | 20000 | 20000 | 20000 | 20000 |
| | | Content | 3.0 | 3.0 | 3.0 | 3.0 | 1.9 | 1.9 |
| | Additives | Urea | 10.0 | 10.0 | 10.0 | 10.0 | 10.0 | 10.0 |
| | | Surfynol 465 | 1.0 | 1.0 | 1.0 | 1.0 | 1.0 | 1.0 |
| | | Surfynol 440 | | | | | | |
| | | proxcel GXL | 0.1 | 0.1 | 0.1 | 0.1 | 0.1 | 0.1 |
| | | DEAS | 1.0 | 1.0 | 1.0 | 1.0 | 1.0 | 1.0 |

| | | | | | | | |
|---|---|---|---|---|---|---|---|
| | Water | remaining | remaining | remaining | remaining | remaining | remaining |
| | | amount | amount | amount | amount | amount | amount |
| | Viscosity (mPa · s) at 25° C. | 13.2 | 11.7 | 8.3 | 10.5 | 12.9 | 14.5 |
| | Ratio (mass %) of Solvent | 100 | 100 | 100 | 100 | 88 | 74 |
| | A in All Water-Soluble | | | | | | |
| | Organic Solvents | | | | | | |
| | Content Mass Ratio | 7.7 | 7.7 | 7.7 | 7.7 | 12.1 | 12.1 |
| | [solvent A/polymer X] | | | | | | |
| | Content Mass Ratio | 6.0 | 6.0 | 3.6 | 4.8 | 9.8 | 9.8 |
| | [coloring material/ | | | | | | |
| | polymer X] | | | | | | |
| Evaluation | Jetting Stability of Ink | B | B | A | A | A | A |
| | Drying Properties of Image | A | A | B | A | B | B |
| | Circulation Suitability of Ink | B | B | B | B | A | B |
| | Image Density | B | B | B | A | A | B |

| | | | Example | Example | Example | Example | Example |
|---|---|---|---|---|---|---|---|
| | | | 21 | 22 | 23 | 24 | 25 |
| Ink | Coloring | Type | Reactive | Reactive | Reactive | Reactive | Reactive |
| | Material | | Black 39 | Black 39 | Black 39 | Orange 13 | Black 39 |
| | | Content | 10.0 | 10.0 | 10.0 | 10.5 | 9.0 |
| | | Type | Reactive | Reactive | Reactive | | Reactive |
| | | | Brown 11 | Brown 11 | Brown 11 | | Brown 11 |
| | | Content | 5.8 | 5.8 | 5.8 | | 6.0 |
| | | Type | Reactive | Reactive | Reactive | | Reactive |
| | | | Orange 12 | Orange 12 | Orange 12 | | Orange 12 |
| | | Content | 2.8 | 2.8 | 2.8 | | 3.0 |
| | | Total Content | 18.6 | 18.6 | 18.6 | 10.5 | 18.0 |
| | | of Coloring | | | | | |
| | | Materials | | | | | |
| | Solvent A | TriEG (150) | | | | | |
| | (the | 2-Py (85) | 5.0 | 5.0 | 5.0 | 5.0 | 5.0 |
| | numerical | GL (92) | | | | | |
| | value in the | EG (62) | 18.0 | 18.0 | 18.0 | 30.0 | 30.0 |
| | brackets | PG (76) | | | | | |
| | corresponds | DEGmME | | | | | |
| | to the | (148) | | | | | |
| | molecular | IPA (60) | | | | | |
| | weight) | DPG (134) | | | | | |
| | Other | TriPG (192) | | 3.0 | 7.0 | | |
| | Solvents | TetraEG (194) | | | | | |
| | Polymer | Type | PVP15K | PEG10K | PEG8K | PEG6K | PEG20K |
| | X | Mw | 15000 | 10000 | 8000 | 6000 | 20000 |
| | | Content | 1.9 | 3.0 | 3.0 | 5.0 | 1.1 |
| | Additives | Urea | 10.0 | 10.0 | 10.0 | 10.0 | 10.0 |
| | | Surfynol 465 | 1.0 | 1.0 | 1.0 | 1.0 | 1.0 |
| | | Surfynol 440 | | | | | |
| | | proxcel GXL | 0.1 | 0.1 | 0.1 | 0.1 | 0.1 |
| | | DEAS | 1.0 | 1.0 | 1.0 | 1.0 | 1.0 |

| | | | | | | |
|---|---|---|---|---|---|---|
| | Water | remaining | remaining | remaining | remaining | remaining |
| | | amount | amount | amount | amount | amount |
| | Viscosity (mPa · s) at 25° C. | 8.8 | 9.3 | 9.4 | 11.6 | 12.8 |
| | Ratio (mass %) of Solvent A | 100 | 88 | 77 | 100 | 100 |
| | in All Water-Soluble Organic | | | | | |
| | Solvents | | | | | |
| | Content Mass Ratio | 12.1 | 7.7 | 7.7 | 7.0 | 31.8 |
| | [solvent A/polymer X] | | | | | |
| | Content Mass Ratio | 9.8 | 6.2 | 6.2 | 2.1 | 16.4 |
| | [coloring material/ | | | | | |
| | polymer X] | | | | | |
| Evaluation | Jetting Stability of Ink | B | A | B | B | B |
| | Drying Properties of Image | A | B | B | B | B |
| | Circulation Suitability of Ink | A | B | B | B | B |
| | Image Density | A | A | A | B | B |

TABLE 3

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Ink | Coloring | Type | Reactive | Reactive | Reactive | Reactive | Reactive | Reactive |
| | Material | | Black 39 | Black 39 | Black 39 | Black 39 | Orange 13 | Black 39 |
| | | Content | 9.0 | 9.0 | 9.0 | 10.0 | 10.5 | 9.0 |
| | | Type | Reactive | Reactive | Reactive | Reactive | | Reactive |
| | | | Brown 11 | Brown 11 | Brown 11 | Brown 11 | | Brown 11 |
| | | Content | 6.0 | 6.0 | 6.0 | 5.8 | | 6.0 |
| | | Type | Reactive | Reactive | Reactive | Reactive | | Reactive |
| | | | Orange 12 | Orange 12 | Orange 12 | Orange 12 | | Orange 12 |
| | | Content | 3.0 | 3.0 | 3.0 | 2.8 | | 3.0 |
| | | Total Content | 18.0 | 18.0 | 18.0 | 18.6 | 10.5 | 18.0 |
| | | of Coloring | | | | | | |
| | | Materials | | | | | | |
| | Solvent A | TriEG (150) | | | | | | |
| | (the | 2-Py (85) | 5.0 | 15.0 | 5.0 | 5.0 | 5.0 | |
| | numerical | GL(92) | | | | | | |
| | value in the | EG (62) | 18.0 | 18.0 | 12.0 | 8.0 | 16.0 | 45.0 |
| | brackets | PG (76) | | | | | | |
| | corresponds | DEGmME | | | | | | |
| | to the | (148) | | | | | | |
| | molecular | IPA (60) | | | | | | |
| | weight) | DPG (134) | | 5.0 | | | 18.0 | |
| | Other | TriPG (192) | | | 10.0 | | | |
| | Solvents | TetraEG (194) | | | | 14.0 | | |
| | Polymer | Type | | | PE-108 | PE-108 | PEG20K | PEG6K |
| | X | Mw | | | 17000 | 17000 | 20000 | 6000 |
| | | Content | | | 3.0 | 3.0 | 0.8 | 6.5 |
| | Additives | Urea | 10.0 | 10.0 | 10.0 | 10.0 | 5.0 | |
| | | Surfynol 465 | 1.0 | 1.0 | 1.0 | 1.0 | | |
| | | Surfynol 440 | | | | | 0.4 | 0.4 |
| | | proxcel GXL | 0.1 | 0.1 | 0.1 | 0.1 | 0.1 | 0.1 |
| | | DEAS | 1.0 | 1.0 | 1.0 | 1.0 | 0.5 | 0.5 |

| | | | | | | | |
|---|---|---|---|---|---|---|---|
| | Water | remaining | remaining | remaining | remaining | remaining | remaining |
| | | amount | amount | amount | amount | amount | amount |
| | Viscosity (mPa · s) at | 5.7 | 10.1 | 13.9 | 14.4 | 10.0 | 12.8 |
| | 25° C. | | | | | | |
| | Ratio (mass %) of Solvent | 100 | 100 | 63 | 48 | 100 | 100 |
| | A in All Water-Soluble | | | | | | |
| | Organic Solvents | | | | | | |
| | Content Mass Ratio | — | — | 5.7 | 4.3 | 48.8 | 6.9 |
| | [solvent A/polymer X] | | | | | | |
| | Content Mass Ratio | — | — | 6.0 | 6.2 | 13.1 | 2.8 |
| | [coloring material/ | | | | | | |
| | polymer X] | | | | | | |
| Evaluation | Jetting Stability of Ink | C | A | A | A | C | D |
| | Drying Properties of Image | A | C | C | D | B | C |
| | Circulation Suitability of Ink | A | C | B | B | B | D |
| | Image Density | A | A | A | A | A | C |

| | | | Comparative | Comparative | Comparative | Comparative | Comparative |
|---|---|---|---|---|---|---|---|
| | | | Example 7 | Example 8 | Example 9 | Example 10 | Example 11 |
| Ink | Coloring | Type | Reactive | Reactive | Reactive | Reactive | Reactive |
| | Material | | Black 39 | Black 39 | Black 39 | Black 39 | Orange 13 |
| | | Content | 9.0 | 9.0 | 9.0 | 9.0 | 10.5 |
| | | Type | Reactive | Reactive | Reactive | Reactive | |
| | | | Brown 11 | Brown 11 | Brown 11 | Brown 11 | |
| | | Content | 6.0 | 6.0 | 6.0 | 6.0 | |
| | | Type | Reactive | Reactive | Reactive | Reactive | |
| | | | Orange 12 | Orange 12 | Orange 12 | Orange 12 | |
| | | Content | 3.0 | 3.0 | 3.0 | 3.0 | |
| | | Total Content | 18.0 | 18.0 | 18.0 | 18.0 | 10.5 |
| | | of Coloring | | | | | |
| | | Materials | | | | | |
| | Solvent A | TriEG (150) | | | | | |
| | (the | 2-Py (85) | | 5.0 | | 5.0 | |
| | numerical | GL(92) | | | | | |
| | value in the | EG (62) | 35.0 | 13.0 | 30.0 | 18.0 | 50.0 |
| | brackets | PG (76) | | | | | |
| | corresponds | DEGmME | | | | | |
| | to the | (148) | | | | | |
| | molecular | IPA (60) | | | | | |
| | weight) | DPG (134) | | | | | |
| | Other | TriPG (192) | | | | | |
| | Solvents | TetraEG (194) | | | | | |
| | Polymer | Type | PEG4K | PEG40K | PEG6K | PEI | PEG10K |
| | X | Mw | 4000 | 40000 | 6000 | 10000 | 10000 |
| | | Content | 5.0 | 1.3 | 5.0 | 1.9 | 0.9 |
| | Additives | Urea | | 10.0 | | 10.0 | |
| | | Surfynol 465 | | 1.0 | | 1.0 | |
| | | Surfynol 440 | 0.4 | | 0.4 | | 0.4 |
| | | proxcel GXL | 0.1 | 0.1 | 0.1 | 0.1 | 0.1 |
| | | DEAS | 0.5 | 1.0 | 0.5 | 1.0 | 0.5 |

| | | | | | | |
|---|---|---|---|---|---|---|
| | Water | remaining | remaining | remaining | remaining | remaining |
| | | amount | amount | amount | amount | amount |
| | Viscosity (mPa · s) at 25° C. | 10.6 | 9.5 | 9.9 | 8.1 | 12.6 |
| | Ratio (mass %) of Solvent A | 100 | 100 | 100 | 100 | 100 |
| | in All Water-Soluble Organic | | | | | |
| | Solvents | | | | | |
| | Content Mass Ratio | 7.0 | 13.8 | 6.0 | 12.1 | 55.6 |
| | [solvent A/polymer X] | | | | | |
| | Content Mass Ratio | 3.6 | 13.8 | 3.6 | 9.5 | 11.7 |
| | [coloring material/ | | | | | |
| | polymer X] | | | | | |
| Evaluation | Jetting Stability of Ink | B | C | C | C | A |
| | Drying Properties of Image | B | A | A | A | B |
| | Circulation Suitability of Ink | C | C | C | A | D |
| | Image Density | A | A | B | B | C |

—Description of Tables 1 to 3—

The unit of the content of each component is mass % with respect to the total amount of the ink.

A blank means that the corresponding component is not contained.

The meanings of the abbreviations of the components are as follows.
TriEG . . . triethylene glycol
2-Py . . . 2-pyrrolidone
GL . . . glycerin
EG . . . ethylene glycol
PG . . . propylene glycol
DEGmME . . . diethylene glycol monomethyl ether
IPA . . . isopropyl alcohol
DPG . . . dipropylene glycol
TriPG . . . tripropylene glycol
TetraEG . . . tetraethylene glycol
Surfynol 465 . . . manufactured by Evonik Industries AG, ethoxylated acetylene diol surfactant
Surfynol 440 . . . manufactured by Evonik Industries AG, ethoxylated acetylene-based surfactant
proxel GXL . . . manufactured by LONZA KK., preservative (20 mass % dipropylene glycol solution of benzisothiazolin-3-one)
DEAS . . . manufactured by EVERLIGHT, 48 mass % aqueous solution of 4-(diethylamino)benzenesulfonic acid
PE-108 . . . “NEWPOL PE-108” manufactured by Sanyo Chemical Industries, Ltd. (copolymer of ethylene glycol and propylene glycol, Mw=17,000)
PVA . . . polyvinyl alcohol (Mw=22,000)
PVP15K polyvinylpyrrolidone (Mw=15,000)
PVP25K polyvinylpyrrolidone (Mw=25,000)
PVP35K polyvinylpyrrolidone (Mw=35,000)
PEG4K . . . polyethylene glycol (Mw=4,000)
PEG6K . . . polyethylene glycol (Mw=6,000)
PEG8K . . . polyethylene glycol (Mw=8,000)
PEG10K . . . polyethylene glycol (Mw=10,000)
PEG20K . . . polyethylene glycol (Mw=20,000)
PEG40K . . . polyethylene glycol (Mw=10,000)
PEI . . . polyethyleneimine (Mw=10,000)

As shown in Tables 1 to 3, the examples using the ink containing: water; a coloring material; a polymer X which is a water-soluble polymer with a weight-average molecular weight of 6,000 to 35,000, including at least one selected from the group consisting of a structural unit derived from alkylene glycol, a structural unit derived from vinyl alcohol, a structural unit derived from vinyl acetate, and a structural unit derived from vinylpyrrolidone; and a solvent A which is a water-soluble organic solvent with a molecular weight of 160 or less, in which a ratio of the solvent A in all water-soluble organic solvents is 70 mass % or greater, a content of the polymer X with respect to a total amount of the ink is 0.9 mass % to 6.0 mass %, and a content mass ratio [solvent A/polymer X] is 7.0 to 50 are excellent in jetting stability of the ink, drying properties of an image, and circulation suitability of the ink.

In Comparative Example 1 in which the ink did not contain the polymer X, the jetting stability of the ink was lowered.

In Comparative Example 2 in which the ink did not contain the polymer X and the content ratio of the solvent A was increased to thicken the ink, the circulation suitability of the ink was lowered.

In Comparative Examples 3 and 4 in which the ratio of the solvent A (low-boiling point solvent) in all the water-soluble organic solvents contained in the ink was less than 70 mass %, the drying properties of the image was lowered.

In Comparative Example 5 in which the content of the polymer X with respect to the total amount of the ink was less than 0.9 mass %, the jetting stability of the ink was lowered.

In Comparative Example 6 in which the content of the polymer X with respect to the total amount of the ink was greater than 6.0 mass %, the jetting stability of the ink, the drying properties of the image, and the circulation suitability of the ink were lowered.

In Comparative Example 7 in which an ink containing a polymer whose Mw was less than 6,000 instead of the polymer X was used, the circulation suitability of the ink was lowered.

In Comparative Example 8 in which an ink containing a polymer whose Mw was greater than 35,000 instead of the polymer X was used, the jetting stability of the ink and the circulation suitability of the ink were lowered.

In Comparative Example 9 in which the content mass ratio [solvent A/polymer X] was less than 7.0, the jetting stability of the ink and the circulation suitability of the ink were lowered.

In Comparative Example 10 in which the polymer X was changed to a polymer other than the polymer X, the jetting stability of the ink was lowered.

In Comparative Example 11 in which the content mass ratio [solvent A/polymer X] was greater than 50, the circulation suitability of the ink was lowered.

The entire disclosure of JP2020-058270 filed on Mar. 27, 2020 is incorporated herein by reference.

All literatures, patent applications, and technical standards described herein are incorporated herein by reference to the same extent as if each literature, patent application, or technical standard is specifically and individually indicated as being incorporated by reference.

What is claimed is:

1. An ink jet textile printing ink comprising:
water;
a coloring material;
a polymer X which is a water-soluble polymer with a weight-average molecular weight of 6,000 to 35,000, including at least one selected from the group consisting of a structural unit derived from alkylene glycol, a structural unit derived from vinyl alcohol, a structural unit derived from vinyl acetate, and a structural unit derived from vinylpyrrolidone; and
a solvent A which is a water-soluble organic solvent with a molecular weight of 160 or less,
wherein a ratio of the solvent A in all water-soluble organic solvents contained in the ink jet textile printing ink is 70 mass % or greater,
a content of the polymer X with respect to a total amount of the ink jet textile printing ink is 0.9 mass % to 6.0 mass %,
a mass ratio of a content of the solvent A to the content of the polymer X is 7.0 to 50, and,
wherein a viscosity of the ink jet textile printing ink at 25° C. is 8 mPa·s to 16 mPa·s.

2. The ink jet textile printing ink according to claim 1, wherein a mass ratio of a content of the coloring material to the content of the polymer X is 2.5 to 15.

3. The ink jet textile printing ink according to claim 1, wherein the coloring material is a reactive dye.

4. The ink jet textile printing ink according to claim 1, wherein the coloring material is at least one selected from the group consisting of
C. I. Reactive Black 5,
C. I. Reactive Black 39,
C. I. Reactive Brown 11,
C. I. Reactive Orange 12,
C. I. Reactive Orange 13,
C. I. Reactive Blue 49,
C. I. Reactive Blue 72,
C. I. Reactive Red 245,
C. I. Reactive Yellow 85, and
C. I. Reactive Yellow 95.

5. The ink jet textile printing ink according to claim 1,
wherein the solvent A is at least one selected from the group consisting of a compound represented by Formula (1), glycerin, and 2-pyrrolidone, 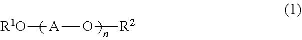
in Formula (1), A represents an ethylene group or a propylene group, R¹ and R² each independently represent a hydrogen atom or an alkyl group, and n is 0 to 3, and
in a case where n is 0, at least one of R¹ or R² is an alkyl group.

6. The ink jet textile printing ink according to claim 1, wherein a content of the coloring material with respect to the total amount of the ink jet textile printing ink is 10 mass % or greater.

7. The ink jet textile printing ink according to claim 1, wherein a content of the solvent A with respect to a total amount of the ink jet textile printing ink is from 10 mass % to 50 mass %.

8. The ink jet textile printing ink according to claim 1, wherein the polymer X is a polymer obtained by polymerizing at least one selected from the group consisting of ethylene glycol, propylene glycol, vinyl alcohol, vinyl acetate, and vinylpyrrolidone.

9. An ink jet textile printing method comprising:
a step of applying the ink jet textile printing ink according to claim 1 to a fabric by an ink jet method; and
a step of heat-treating the fabric on which the ink jet textile printing ink is applied.
